(19) United States
(12) Patent Application Publication
(10) Pub. No.: US 2018/0139501 A1
(43) Pub. Date: May 17, 2018

(54) OPTIMIZED DELIVERY OF SEQUENTIAL CONTENT BY SKIPPING REDUNDANT SEGMENTS

(71) Applicant: THOMSON Licensing, Issy-les-Moulineaux (FR)

(72) Inventors: Brian Charles ERIKSSON, San Jose, CA (US); Jean BOLOT, Los Altos, CA (US); Azin ASHKAN, Los Angeles, CA (US)

(21) Appl. No.: 15/737,383

(22) PCT Filed: May 12, 2016
(86) PCT No.: PCT/US16/32089

§ 371 Date: Dec. 18, 2017

Related U.S. Application Data
(60) Provisional application No. 62/184,009, filed on Jun. 24, 2015.

(51) Int. Cl. H04N 21/4545; H04N 21/262; H04N 21/45; H04N 21/458; H04N 21/845

(52) U.S. Cl. CPC H04N 21/45457; H04N 21/26258; H04N 21/8456; H04N 21/458; H04N 21/4532

(57) ABSTRACT

Ways to provide optimized content for sequential viewing are described. A processing server (120) may be able to retrieve source content from a storage (110). The processing server (120) may optimize the content by removing redundant and irrelevant segments. The processing server may further accelerate a playback speed associated with the optimized content. The redundancy and/or relevancy of segments may be determined based at least partly on the subject matter included in the segments, user preferences, and/or other relevant factors. The processing server (120) may receive data from multiple analytics resource and use the data to identify relevant and/or redundant segments. The processing server may provide optimized content to a content server (140) which may, in turn, provide the content to a user device (150) for playback. Alternatively, the optimized content may be generated at the user device.

### BACKGROUND

Many consumers receive media content via one or more streaming services. Such services allow on-demand viewing of several content items (e.g., a set of sequential episodes of a TV show). Binge-watching has become increasingly popular as consumers discover new shows and watch several episodes in a row during a single viewing session.

Such binge-watching sessions can be unnecessarily time consuming as a viewer repeatedly sees the same introductory sequences, exit sequences or ending credits, etc. In addition, viewers may be more interested in particular storylines, characters, and/or other elements that may not be associated with sequential episodes.

Thus there is a need for ways to provide content that limits redundant elements, considers the connection among content segments, and tailors the experience based on relevant criteria.

### SUMMARY

Some embodiments generate and/or provide optimized content. Such content may include a number of sequential associated segments each of which may include video, audio, graphics, and/or other types of multimedia content. In some embodiments, such segments may be automatically identified based on the subject matter of a source content item (e.g., multiple episodes of a television (TV) show).

The optimized content may be generated, stored, and made available for viewing or be generated at view time. The optimized content may be associated with data including various operating parameters that may at least partly control the presentation of the optimized content on a user device.

Some embodiments may optimize content by determining whether various segments are redundant. Such determinations may be made based on various relevant factors (e.g., similarity of a segment to one or more other segments, label or description of a segment, etc.). The redundant items may be omitted from the optimized version of the content or not repeated (e.g., a TV intro segments may be played once before multiple episodes are played).

In some embodiments, the segments may be evaluated to determine whether the segments are relevant and/or to generate a relevance score, metric, or ranking). The content may then be further optimized by omitting segments that are irrelevant or that fall below some relevance threshold. Such relevance may be based on consideration of various appropriate factors such as characters included in the segment, user preference (e.g., a designated preference to omit segments associated with a particular story line or character), etc.

Relevance may be based on analysis of user-accessible platforms in some embodiments. For instance, data associated with one or more social media platforms may be analyzed to help determine relevance of segments (e.g., by evaluating comments referring to specific scenes, characters, etc.).

Some embodiments may accelerate playback for optimized content such that playback time is reduced. Such acceleration may be implemented by modifying the content and/or adjusting a playback speed parameter recognized by one or more media players.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of a hardware system according to an exemplary embodiment;

FIG. 2 illustrates a schematic block diagram of an exemplary processing device;

FIG. 3 illustrates a flow chart of an exemplary process that optimizes content for sequential viewing;

FIG. 4 illustrates a flow chart of an exemplary process that analyzes social media to determine relevancy of content;

FIG. 5 illustrates a flow chart of an exemplary client-side process that provides sequential viewing content;

FIG. 6 illustrates a flow chart of an exemplary server-side process that provides sequential viewing content; and

FIG. 7 illustrates a schematic block diagram of an exemplary computer system that implements some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments generally provide ways to generate, distribute, and/or consume optimized content. Such content may be optimized based on redundancy, relevance, analytics, and/or other relevant factors. In addition, content optimization may include playback acceleration.

Several advantages may be associated with the optimized content. First, the user experience may be improved as a user is able to consume multiple content items such as TV episodes with fewer interruptions and within a shorter time period. Such an approach allows a user to consume more content over a given time period or viewing window. Second, on-demand or a la carte content providers may be able provide more content within a shorter time period so that a user may select additional content within any available viewing time.

A first exemplary embodiment provides a method that generates optimized content for sequential consumption. The method includes retrieving a set of source content items, identifying multiple segments within each source content item, identifying a set of redundant segments, and generating at least one optimized content item that omits the set of redundant segments.

A second exemplary embodiment provides a processing device that generates optimized content for sequential consumption. The processing device includes a processor for executing a set of instructions and a tangible non-transitory medium that stores the set of instructions. The set of instructions includes retrieving a set of source content items, identifying multiple segments within each source content item, identifying a set of redundant segments from among the segments, and generating at least one optimized content item that omits the set of redundant segments.

A third exemplary embodiment provides a method that provides, at a user device, optimized content for sequential playback. The method includes retrieving a set of operating parameters associated with a set of optimized content items, sending, to a server, a request for the set of optimized content items, receiving, from the server, a response to the request, wherein the response includes at least one content item, and providing the set of optimized content items for playback.

A fourth exemplary embodiment provides a user device that provides optimized content for sequential playback. The user device includes a processor for executing a set of instructions and a non-transitory medium that stores the set of instructions. The set of instructions includes retrieving a set of operating parameters associated with a set of optimized content items, sending, to a server, a request for the set of optimized content items, receiving, from the server, a response to the request, wherein the response includes at least one content item, and providing the set of optimized content items for playback.

A fifth exemplary embodiment provides a method that provides, at a server, optimized content for sequential playback. The method includes receiving, from a client, a request for a set of optimized content items, retrieving at least one source content item associated with the set of optimized content items, optimizing the received content, and sending the set of optimized content items to the client.

A sixth exemplary embodiment provides a server that provides optimized content for sequential playback. The server includes a processor for executing a set of instructions and a tangible non-transitory medium that stores the set of instructions. The set of instructions includes receiving, from a client, a request for a set of optimized content items, retrieving at least one source content item associated with the set of optimized content items, optimizing the received content, and sending the set of optimized content items to the client.

Several more detailed embodiments are described in the sections below. Section I provides a description of an exemplary system architecture. Section II then describes exemplary methods of operation. Lastly, Section III describes an exemplary computer system.

### I. System Architecture

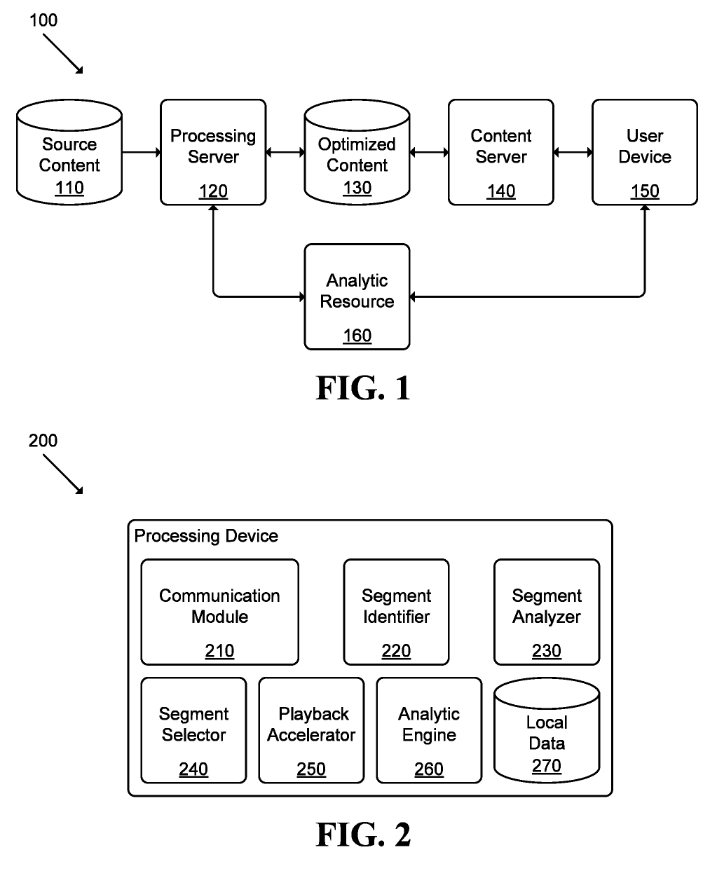

FIG. 1 illustrates a schematic block diagram of a hardware system 100 according to an exemplary embodiment. As shown, the system may include a source content storage 110, a processing server 120, optimized content storage 130, a content server 140, a user device 150, and an analytic resource 160.

Each source content storage 110 may be a device capable of storing media content. The system 100 may include multiple source content storages 110 that may be associated in various different ways (e.g., multiple storages may be associated with a single content provider, multiple content providers may each provide sets of storages, etc.). The storage may be accessible across various networks or communication pathways. In some embodiments, the storage may be accessed via an application programming interface (API) and/or other appropriate resources.

The source content may include content items associated with, for example, TV shows, clips, movies, web series, podcasts, music videos, etc. Source content may be associated based on various relevant factors. For instance, episodes from a series may be generally linked together as a set and individual episodes may be linked to other episodes in an ordered playlist. Other examples of associated source content include movies (e.g., grouped by director, genre, cast, etc.), audio tracks from an album, sports highlights (e.g., grouped by sport, by region, by team etc.), web clips or other content provided in a shared playlist, etc. The source content may be linked automatically based on the above factors and/or based on selections received from a user (e.g., by selecting a sub-set of episodes or movies from among a presented list or grouping).

The processing server 120 may be a computing device able to execute instructions and/or process data. The processing server may be able to retrieve content from the sources 110.

The optimized content storage 130 may receive optimized content from the processing server 120. In some embodiments, source content and optimized content may be stored in a single storage (where the single storage may include multiple devices distributed across multiple locations).

The content server 140 may be a computing device that is able to provide optimized content (and/or other content). In some embodiments, the content server functionality may be provided by the processing server 120.

Each user device 150 may be an electronic device capable of providing content to a user. Such devices may include, for instance, personal computers, tablets, smartphones, laptops, TVs, gaming consoles, etc. In some embodiments, the user device 150 may serve as the processing server and receive source content (e.g., directly from storage 110, via server 140, etc.) that is then optimized at the user device.

Each analytic resource 160 may be a service (e.g., a social media platform) that is able to provide data regarding user opinions regarding content. In addition, each analytic resource 160 may be able to analyze the data to extract relevant information that may be used to optimize sequential content. In some embodiments, the analytic resource 160 may provide only data and any analysis may be performed by the processing server 120.

As an example use case, the processing server 120 may retrieve source content from storage 110 and automatically optimize the content. The content may include several episodes of a TV show (e.g., two to six episodes, a season of episodes, etc.) and may be optimized by removing redundant introduction sections and ending credits. In some embodiments, a single introduction may be followed by multiple episodes of the show, which may be followed by a single ending sequence. The content may be further optimized by removing segments related to minor characters, subplots, and/or other elements. The optimized content may be stored at storage 130 and made available via server 140. User device 150 may request optimized content (e.g., by indicating that optimized content is preferred in a content request). During playback, the user device 150 may only play the segments included in the optimized content resulting in a more efficient, less time-consuming consumer experience.

Although the system 100 has been described by reference to various exemplary details, one of ordinary skill in the art will recognize that the system may be implemented in various other ways without departing from the scope of the disclosure. For instance, some embodiments may include additional elements or omit some elements. As another example, the elements may be arranged in different specific ways with different communication pathways. In addition, some embodiments may include multiple instances of each type of element (e.g., multiple analytic resources associated with multiple external platforms, multiple user devices associated with multiple different users, etc.).

FIG. 2 illustrates a schematic block diagram of an exemplary processing device 200. The processing device 200 may be implemented by a device such as processing server 120, user device 150, and/or combinations of similar elements. As shown, the processing device 200 may include a communication module 210, a segment identifier 220, a segment analyzer 230, a segment selector 240, a playback accelerator 250, an analytic engine 260, and local data 270.

The communication module 210 may allow the processing device 200 to communicate across one or more networks or interfaces in order to communicate with other system elements (e.g., content storages, user devices, analytic resources, etc.).

The segment identifier 220 may be able to evaluate content items and divide the content into applicable segments. For instance, a TV show may include an introduction, a set of acts, and an ending sequence. The segment identifier may be able to determine begin and end points of each segment. In some cases, the content may include headers, tags, and/or other data that may automatically define the various segments. The content may include descriptions of the segments or other information that may help evaluate the content.

The segment analyzer 230 may be able to analyze content included in the various identified segments. For instance, the analyzer may determine that a segment (e.g., an introduction for a TV show) is redundant when compared with other segments in a content item. As another example, the analyzer may determine the relevancy of a segment based on various appropriate factors (e.g., user preferences, analysis of segment descriptions, etc.).

The segment selector 240 may identify a set of segments to include in a collection based on some appropriate criteria. For instance, the segment selector may identify multiple episodes of a TV show, may identify multiple different shows related to a particular entertainer, etc. In addition, the segment selector may remove redundant segments from a collection (e.g., a season of episodes), may remove segments that are not relevant (e.g., related to minor characters or “B” stories), and/or otherwise modify the source content. The segment selector may generate a listing of segments and a playback order. In addition, various associated parameters and/or flags may be included in the listing (e.g., skip if only main plot is selected, playback always, etc.). The listing may include various playback parameters (e.g., playback acceleration, skip redundant, etc.). In some embodiments, a content file may be generated based on the set of segments (and/or associated parameters). Alternatively, the listing may refer to sets of other content items (and/or locations therein).

The playback accelerator 250 may speed up content playback by a specified amount (e.g., five per cent). Such a change may allow more content to be viewed in a shorter period of time without noticeably affecting the quality of the content.

The analytic engine 260 may retrieve data from various sources (e.g., social media sites) and perform analysis to determine relevancy for various segments. Such analysis may be based on mentions of various storylines, characters, etc. Such relevancy determination may be used by the segment selector 240 to pare irrelevant subject matter.

Local data 270 may include data structures and data stored at the processing device 200. Such data may include content, optimized content, user data, analytic data, etc.

Although the various modules are represented as being included in one device, some embodiments may distribute some or all modules across multiple devices as appropriate. For example, some embodiments may partially optimize content at a device such as processing server 120 using modules such as the segments identifier 220, segment analyzer 230, and segment selector 240. The content may be further optimized at a user device 150 by a module such as playback accelerator 250 and/or be further optimized at the user device 150 by additional processing by modules such as the segment selector 240 based on locally stored user data.

While device 200 has been described by reference to various exemplary details, one of ordinary skill in the art will recognize that the device may be implemented in various other ways without departing from the scope of the disclosure. For instance, some embodiments may include additional elements or omit some elements.

### II. Methods of Operation

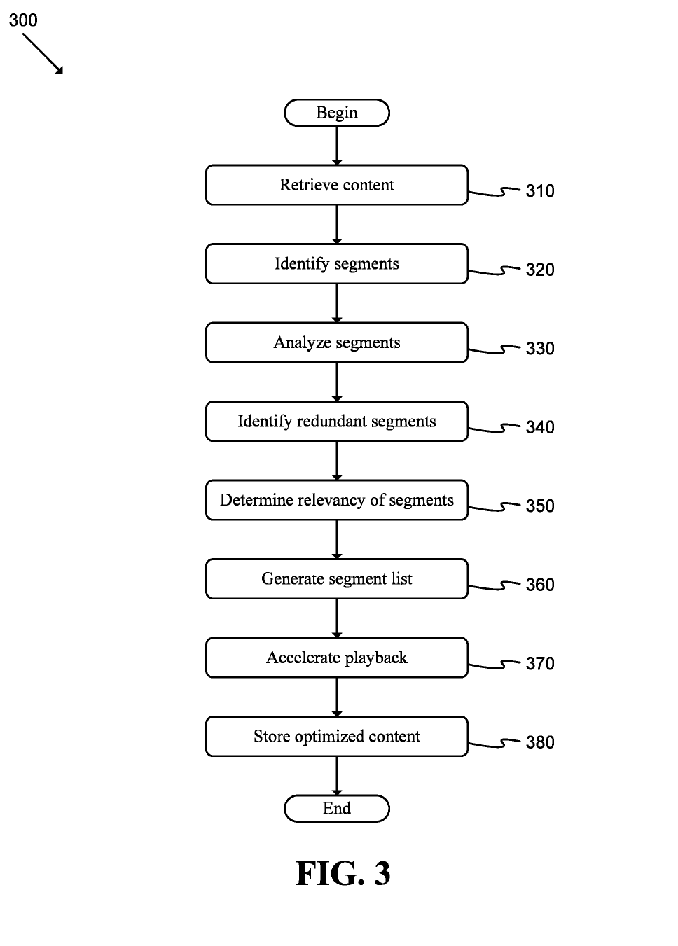

FIG. 3 illustrates a flow chart of an exemplary process 300 that optimizes content for sequential viewing. The process may be executed by an element such as processing server 120 or user device 150 (or a combination of such elements). The process 300 may begin, for instance, when content becomes available, when a user selects a sequential viewing mode, etc.

As shown, the process 300 may retrieve (at 310) content. Such content may be retrieved from a storage such as storage 110. Next, the process 300 may identify (at 320) segments within the content. Such an operation may be performed by an element such as segment identifier 220. The segments may be identified based on various relevant criteria. In some cases, the content may define the various segments in a header, tag, etc. Alternatively, the content may be automatically divided into segments based on analysis of content (e.g., by identifying transitions or “cuts”, by identifying black screen or lack of sound, etc.). Such segments may be associated with features of the content (e.g., each segment may correspond to a scene, act, etc.).

In some embodiments, the segments may be divided to a level of sub-scenes or “clips”. Such clips may be identified based on various relevant factors (e.g., analysis of content, segmentation at defined time intervals, etc.).

The process 300 may then analyze (at 330) the identified segments. Such analysis may be performed by an element such as segment analyzer 230. Next, the process 300 may identify (at 340) redundant segments. Such identification may be performed by an element such as segment analyzer 230.

Redundant segments may be identified in various appropriate ways. For instance, the content itself may include headers, tags, etc. that identify various sections of the content (e.g., show introduction, act 1, act 2, ending credits, etc.) and allow for the redundant segments to be identified across a group of content items. Commonalities among episodes (or other content items) may be automatically identified by comparing content segments to each other (e.g., based on length of content, file size or type, etc.). In some cases, possible redundancies may be identified and further evaluated (e.g., based on user feedback, social media analytics, comparison of data stream, etc.).

The process 300 may then determine (at 350) the relevancy of the various segments. Such a determination may be made in various appropriate ways (e.g., based on analysis of content descriptions, social media feedback, user preference, etc.). In some cases, the process 300 may associate various tags or descriptive elements to the segments potentially related to the relevancy of the segments (e.g., names of characters featured in the segments, plot synopsis, etc.). In this way, the relevancy of segments may be adjusted depending on various factors (e.g., end-user preferences, maximum specified viewing time, etc.). In addition, the relevancy may be represented in various different ways (e.g., as a binary relevant/not relevant flag, as an overall relevancy score, as a relevancy score associated with a tag or keyword, etc.).

Next, process 300 may generate (at 360) a segment list. The list may be generated by an element such as segment selector 240. Such a list may include all or a subset of the segments identified at 320.

In some cases, in addition to identifying (at 340) the redundant segments, and determining (at 350) the relevance of each segment, the process may eliminate some or all of such segments from the segment list generated at 360. Alternatively, a flag or other indication may be associated with the content such that the content may be automatically presented or skipped during playback on a user device.

The process 300 may then (at 370) accelerate playback of the segments in the list. The playback acceleration may be performed by an element such as playback accelerator 250. Such acceleration may be based on various relevant factors. For instance, any acceleration factor may be based on previous user interactions where a user may indicate a preference for a particular level of acceleration. As another example, the content itself may be analyzed to determine an appropriate acceleration factor (e.g., dialog or action sequences may be accelerate more than musical numbers, sub-plot scenes may be accelerated more than scenes in a main plotline, etc.).

Next, the process may store (at 380) the optimized content based on the segment list and then may end. Such content may be saved to a storage such as storage 130 and/or may be made available to a server or other resource such as content server 140. In some cases the optimized content may be generated at an end-user device and may only be stored locally for use during playback.

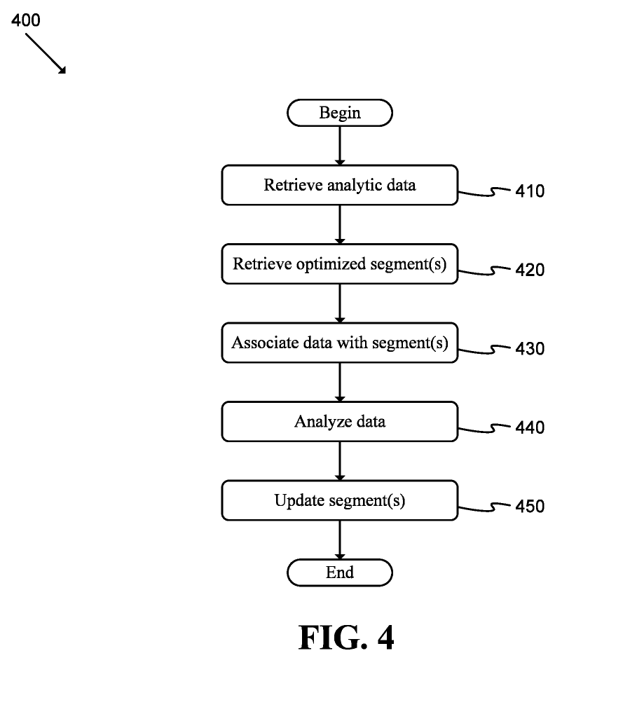

FIG. 4 illustrates a flow chart of an exemplary process 400 that analyzes social media to determine relevancy of content. The process 400 may be executed by an element such as processing server 120, user device 150 (or a combination of such elements), and/or analytic engine 260. In addition, the process may utilize an element such as analytic resource 160 to provide data for analysis.

As shown, the process 400 may retrieve (at 410) analytic data. Such data may be retrieved from various appropriate sources (e.g., content providers, social media platforms, user feedback, etc.).

Next, the process 400 may retrieve (at 420) one or more optimized content segments. Alternatively, non-optimized source content may be retrieved when optimized content is not available. The appropriate segments may be identified based at least partly on the analytic data retrieved at 410.

The analytic data and/or content may be retrieved by the communication module 210 from an external storage or other appropriate resource (e.g., an API, a web-based interface, etc.).

Process 400 may then associate (at 430) the analytic data with one or more segments. Such an operation may be performed by an element such as analytic engine 260.

Next, the process 400 may analyze (at 440) the analytic data and any data associated with the content. For instance, as described above, each segment may include a relevancy flag, relevancy score, redundancy information, etc. Such analysis may result in updated scores, flags, associated data, etc.

The process 400 may then update (at 450) the segments based on the analysis performed at 440 and then may end. The update may include overwriting existing segment data, updating header or link data related to other segments, etc.

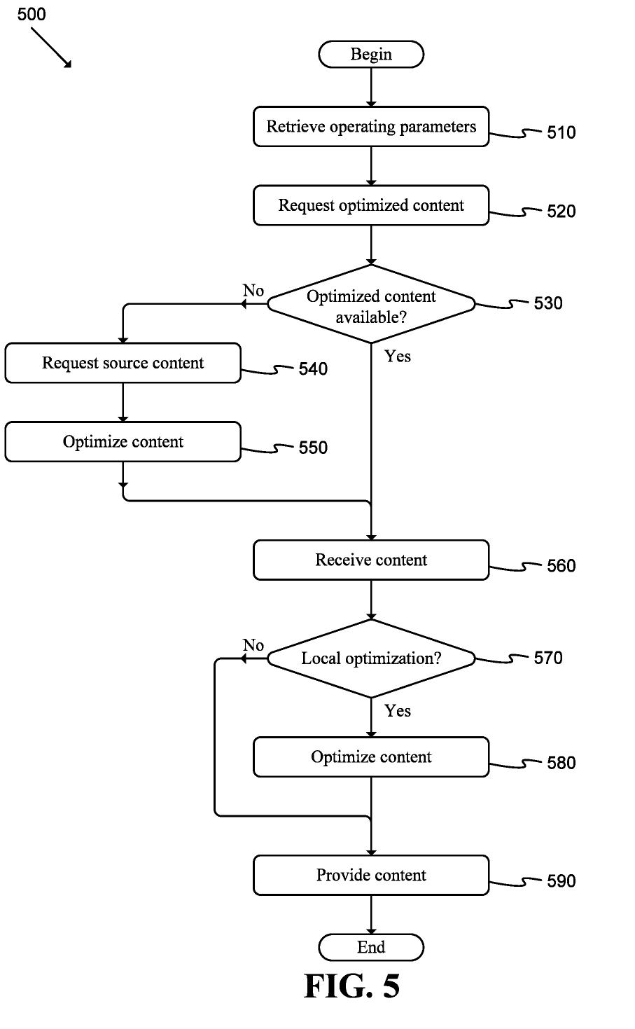

FIG. 5 illustrates a flow chart of an exemplary client-side process 500 that provides sequential viewing content. Such a process may be executed by a device such as user device 150. The process may begin, for instance, when a user launches a content player or service.

As shown, the process 500 may retrieve (at 510) a set of operating parameters. The operating parameters may be based on various relevant criteria (e.g., user selection or preference, default settings, etc.). The operating parameters may include, in addition to various technical performance elements (e.g., device type, connection type of speed, network status, etc.), user-specific parameters (e.g., user-specified values and/or flags, playback control commands received, etc.), content-specific parameters (e.g., social media analytics, default settings, etc.), and/or other appropriate parameters. In some embodiments, the process 500 may retrieve the operating parameters by sending a request to a server-side process and receiving a response.

Next, the process 500 may request (at 520) optimized content from an appropriate resource (e.g., content server 140). Alternatively, if sequential viewing is disabled or unavailable, default content may be requested. The request may be based on selections received from a user (e.g., a selection of a TV show or movie, receipt of a begin playback command, etc.), previous viewing data (e.g., stop point of an earlier viewing session, a next content item in a series, etc.), etc.

The process 500 may then determine (at 530) whether optimized content is available. Such a determination may be made based on various relevant factors (e.g., response received from a server-side process indicating no optimized content is available, by determining that the server-side process does not support sequential viewing, etc.).

If the process 500 determines (at 530) that no optimized content is available, the process 500 may request (at 540) source content from an appropriate resource. The process 500 may then receive and optimize (at 550) the source content. Such optimization may be performed in a similar manner to that described above in reference to process 300.

After determining (at 530) that optimized content is available or after optimizing (at 550) the content, the process 500 may receive (at 560) the optimized content. Such content may be received from a server-side resource or from a local storage when optimized at the client. In addition to or in place of being optimized, the optimized content may include updated operating parameters (e.g., playback speed, skip redundant flag, etc.). Such operating parameters may be stored with the content (e.g., as header information, included in a command register, etc.) and/or may be stored separately either by the user device or a network resource.

The process 500 may then determine (at 570) whether local optimization is needed. As described above, such local optimization may include additional optimization based on user preferences, selections, viewing history, etc. For instance, a user may manually adjust playback acceleration to a desired level during viewing (where such an adjustment may be applied to future viewing sessions). As another example, if a user skips (e.g., by fast-forwarding or selecting a “next” option) content that has identifiable features in common (e.g., characters, plot line, etc.) then the playback may be updated to automatically skip similar segments within the already optimized content.

If the process 500 determines (at 570) that local optimization is needed, the process 500 may then optimize (at 580) the content. Such optimization may be performed by the end-user device and/or may be performed by requesting updated content based on updated operating parameters from an external resource, and/or associating updated operating parameters with the content.

After determining (at 570) that no local optimization is necessary or after optimizing (at 580) the content, the process 500 may provide (at 590) the optimized content and then may end. Providing the content may include sending multimedia data to a resource such as a player application.

In addition, as the content is provided, the process may continue to monitor user adjustment of operating parameters (e.g., by adjusting a playback speed, by electing to skip “B” stories, etc.) and/or other commands or selection received from the user (e.g., adjustments to playback, skipping segments, etc.) and further optimize content or request updated content from an external resource based on the updated operating parameters. Such updates may also include storing updated versions of optimized content items with different specified elements or operating parameters.

The process may also store any updates (locally and/or to a server) such that future viewing sessions will reflect the most up to date user preferences and/or other operating parameters (e.g., player type, available bandwidth, etc.).

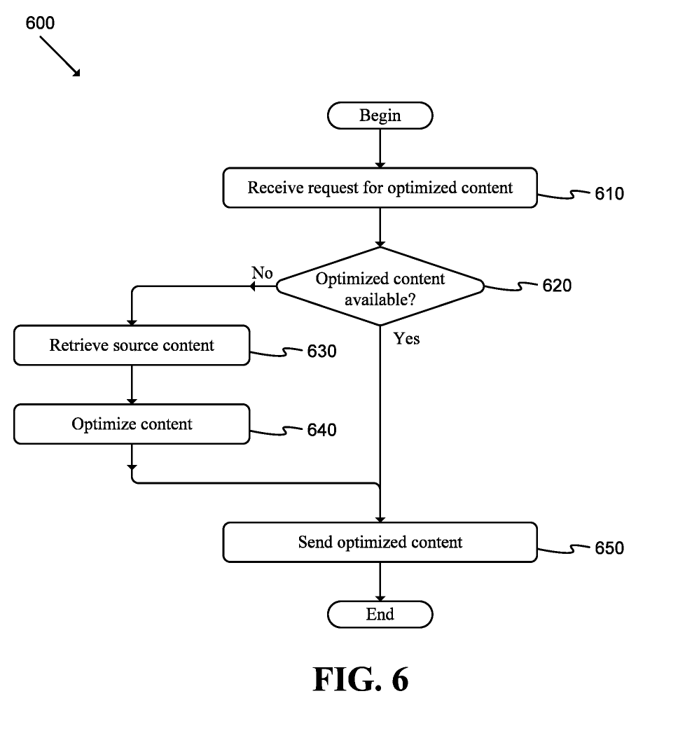

FIG. 6 illustrates a flow chart of an exemplary server-side process 600 that provides sequential viewing content. Such a process 600 may be executed by an element such as content server 140 and/or processing server 120. Process 600 may serve as a complement to process 500. Process 600 may begin, for instance, when content is made available for viewing.

As shown, the process may receive (at 610) a request for optimized content. Such a request may be received from a client-side application and/or other appropriate resource (e.g., a player). If a request for non-optimized content is received, the process may respond with the original source content, as appropriate.

Next, the process 600 may determine (at 620) whether optimized content is available. If the process 600 determines that no optimized content is available, the process may retrieve (at 630) source content and optimize (at 640) the content. Such optimization may be performed in a similar manner to that described above in reference to process 300.

After determining (at 620) that optimized content is available or after optimizing (at 640) the process 600 may send (at 650) optimized content to the client and then may end. As above, the process may continue to monitor data associated with the viewing session and send (and/or apply and store) various updated optimized content items, as appropriate.

One of ordinary skill in the art will recognize that processes 300-600 are exemplary in nature and may be implemented in various different ways without departing from the scope of the disclosure. For instance, the operations may be performed in different orders, different operations may be included, and/or some operations may be omitted. In addition, the processes (and/or portions thereof) may be performed iteratively, at regular intervals, and/or based on some specified criteria. Furthermore, each process may be performed as a part of a macro-process and/or be divided into multiple sub-processes.

### III. Computer System

Many of the processes and modules described above may be implemented as software processes that are specified as one or more sets of instructions recorded on a non-transitory tangible storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

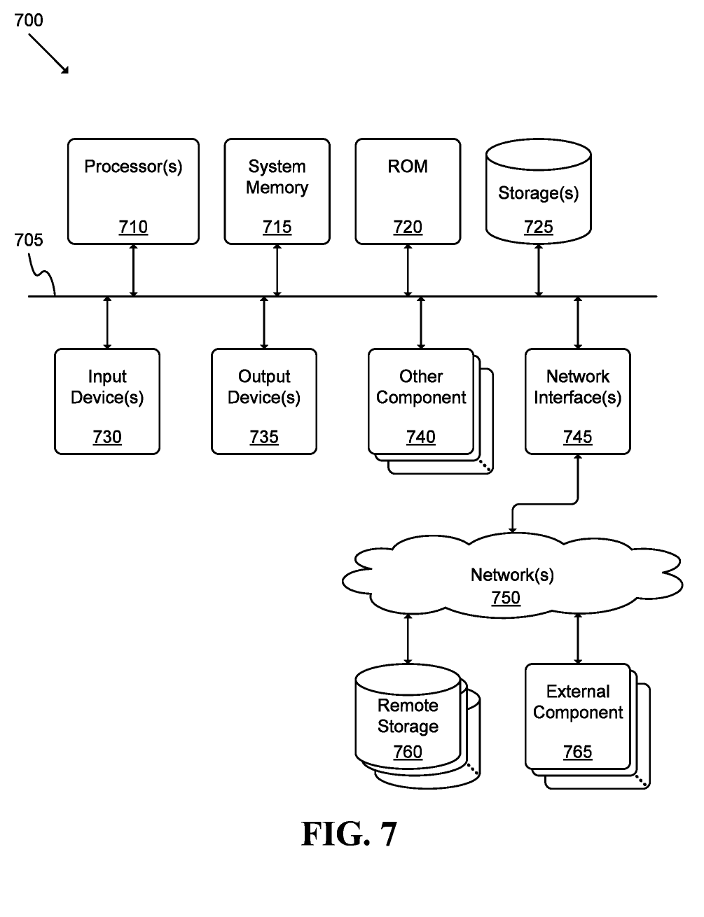

FIG. 7 illustrates a schematic block diagram of an exemplary computer system 700 used to implement some embodiments. For example, the system described above in reference to FIGS. 1-2 may be at least partially implemented using computer system 700. As another example, the processes described in reference to FIGS. 3-6 may be at least partially implemented using sets of instructions that are executed using computer system 700.

Computer system 700 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 700 may include at least one communication bus 705, one or more processors 710, a system memory 715, a read-only memory (ROM) 720, permanent storage devices 725, input devices 730, output devices 735, various other components 740 (e.g., a graphics processing unit), and one or more network interfaces 745.

Bus 705 represents all communication pathways among the elements of computer system 700. Such pathways may include wired, wireless, optical, and/or other appropriate communication pathways. For example, input devices 730 and/or output devices 735 may be coupled to the system 700 using a wired or wireless connection protocol or system.

The one or more processors 710 may, in order to execute the processes of some embodiments, retrieve instructions to execute and/or data to process from components such as system memory 715, ROM 720, and permanent storage device 725. Such instructions and data may be passed over bus 705.

System memory 715 may be a volatile read-and-write memory, such as a random access memory (RAM). The system memory may store some of the instructions and data that the processor uses at runtime. The sets of instructions and/or data used to implement some embodiments may be stored in the system memory 715, the permanent storage device 725, and/or the read-only memory 720. ROM 720 may store static data and instructions that may be used by processor 710 and/or other elements of the computer system.

Permanent storage device 725 may be a read-and-write memory device. The permanent storage device may be a non-volatile memory unit that stores instructions and data even when computer system 700 is off or unpowered. Computer system 700 may use a removable storage device and/or a remote storage device as the permanent storage device.

Input devices 730 may enable a user to communicate information to the computer system and/or manipulate various operations of the system. The input devices may include keyboards, cursor control devices, audio input devices and/or video input devices. Output devices 735 may include printers, displays, and/or audio devices. Some or all of the input and/or output devices may be wirelessly or optically connected to the computer system.

Other components 740 may perform various other functions. These functions may include performing specific functions (e.g., graphics processing, sound processing, etc.), providing storage, interfacing with external systems or components, etc.

Finally, as shown in FIG. 7, computer system 700 may be coupled to one or more networks 750 through one or more network interfaces 745. For example, computer system 700 may be coupled to a web server on the Internet such that a web browser executing on computer system 700 may interact with the web server as a user interacts with an interface that operates in the web browser. Computer system 700 may be able to access one or more remote storages 760 and one or more external components 765 through the network interface 745 and network 750. The network interface(s) 745 may include one or more application programming interfaces (APIs) that may allow the computer system 700 to access remote systems and/or storages and also may allow remote systems and/or storages to access computer system 700 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 700 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that generates, at a processing device, optimized content for sequential consumption, the method comprising:
retrieving a set of source content items;
identifying a plurality of segments within each source content item;
identifying a set of redundant segments from among the pluralities of segments;
determining a relevance score for each segment;
identifying a set of irrelevant segments having a relevance score less than a specified value; and
generating at least one optimized content item that omits the set of Irrelevant segments.

2. (canceled)

3. The method of claim 1 further comprising generating at least one optimized content item with an accelerated playback speed.

4. The method of claim 1 further comprising storing the at least one optimized content item to a storage accessible to a plurality of user devices.

5. The method of claim 1 further comprising providing the at least one optimized content item to a media player.

6. A processing device that generates optimized content for sequential consumption, the processing device comprising:
a processor for executing a set of instructions; and
a non-transitory medium that stores the set of instructions, wherein the set of instructions comprises: retrieving a set of source content items;
identifying a plurality of segments within each source content item;
identifying a set of redundant segments from among the pluralities of segments; and identifying a set of irrelevant segments having a relevance score less than a specified value; and
generating at least one optimized content that omits the set of irrelevant segments.

7. (canceled)

8. The processing device of claim 6, wherein the set of instructions further comprises generating at least one optimized content item with an accelerated playback speed.

9. The processing device of claim 6, wherein the set of instructions further comprises storing the at least one optimized content item to a storage accessible to a plurality of user devices.

10. The processing device of claim 6, wherein the set of instructions further comprises providing the at least one optimized content item to a media player.

11. A method that provides, at a user device, optimized content for sequential playback, the method comprising:
retrieving a set of operating parameters associated with a set of optimized content items;
sending to a server, a request for the set of optimized content items;
receiving from the server, a response to the request, wherein the response includes at least one content item; and providing the set of optimized content items for playback.

12. (canceled)

13. The method of claim 11, wherein the at least one content item comprise the set of optimizes content items, further comprising: identifying a plurality of segments within the set of optimized content items; determining a relevance score for each segment based on a set of user preferences; and removing each segment if the relevance score is below a particular threshold.

14. (canceled)

15. (canceled)

16. A user device that provides optimized content for sequential playback, the user device comprising:
a processor for executing a set of instructions; and
a non-transitory medium that stores the set of instructions, wherein the set of instructions comprises:
retrieving a set of operating parameters associated with a set of optimized content items;
sending to a server, a request for the set of optimized content items;
receiving from the server, a response to the request, wherein the response includes at least one content item.

17. (canceled)

18. (canceled)

19. The user device of claim 16, wherein the set of instructions further comprises:
identifying a plurality of segments within the at least one content item;
identifying a set of redundant segments from among the plurality of segments;
determining a relevance score for each segment and identifying a set of irrelevant segments having a relevance score less than a specified value; and
removing the irrelevant and redundant segments from the plurality of segments.

20. (canceled)

21. A method that provides, at a server, optimized content for sequential playback, the method comprising:
receiving from a client, a request for a set of optimized content items;
retrieving at least one source content item associated with the set of optimized content items;
optimizing the received content; and
sending the set of optimized content items to the client.

22. (canceled)

23. (canceled)

24. A server that provides optimized content for sequential playback, the server comprising:
a processor for executing a set of instructions; and
a non-transitory medium that stores the set of instructions, wherein the set of instructions receiving from a client, a request for a set of optimized content items; retrieving at least one source content item associated with the set of optimized content items; comprises:
optimizing the received content; and
sending the set of optimized content items to the client.

25. The server of claim 24, wherein the set of instructions further comprises:
identifying a plurality of segments within the at least one source content item;
identifying a set of redundant segments from among the plurality of segments;
determining a relevance score for each segment and identifying a set of irrelevant segments having a relevance score less than a specified value; and
removing the irrelevant and redundant segments from the plurality of segments.

26. (canceled)
